(19) United States
(12) Patent Application Publication
(10) Pub. No.: US 2008/0043380 A1
(43) Pub. Date: Feb. 21, 2008

(54) Magnetoresistive element and manufacturing method thereof

(75) Inventor: Masanori Akie, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/712,702

(22) Filed: Mar. 1, 2007

(30) Foreign Application Priority Data
Aug. 21, 2006 (JP) 2006-223981

(51) Int. Cl. G11B 5/33

(52) U.S. Cl. 360/324.11

(57) ABSTRACT

Intensity of the longitudinal bias field applied to a free soft magnetic layer in a magnetoresistive element can be adjusted after formation, by providing of a composite ferromagnetic layer for longitudinally biasing the free soft magnetic layer. The composite ferromagnetic layer has sub-ferromagnetic layers 15a, 15b, and 15c having different coercive forces. The intensity of the longitudinal bias field is adjusted by inversely rotating the fields of one or more sub-ferromagnetic layers by 180° or 90°, by applying external magnetic fields of appropriate intensity.

This invention relates to a magnetoresistive element and a manufacturing method thereof, and more specifically to a composite ferromagnetic layer that longitudinally biases a soft magnetic layer in an adjustable manner.

### BACKGROUND OF THE INVENTION

A magnetic head used for magnetic disk drives is shown in FIG. 1. This magnetic head includes a read head 4 and a write head 9. The read head 4 has a lower shield layer 1 and an upper shield layer 3 that sandwich a magnetoresistive element 2 (GMR element, TMR element) for reading. The write head 9 has a lower magnetic pole 5 and an upper magnetic pole 7 that create a write gap 6 and complete a magnetic circuit around a coil 8 for recording.

A conventional magnetoresistive element used in the magnetic head is shown in FIG. 2. FIG. 2 is a side view of the magnetoresistive element when the surface opposing a medium is viewed from the medium side, i.e., the left side of FIG. 1.

An element 10 for detecting a magnetic field has a free layer 11 formed of a soft magnetic layer, a pinned layer 12, an antiferromagnetic layer 13 for pinning the pinned layer, and an intermediate layer 14 provided between the free layer 111 and the pinned layer 12. Magnetization of the pinned layer 12 is pinned in a constant direction by the antiferromagnetic layer 13. The angle of the magnetization of free layer 11 changes in response to the magnetic field of the medium.

The intermediate layer 14 is formed of a conductive material of Cu or the like. Moreover, ferromagnetic layers 15 are located on both sides of the element 10 via an underlayer 16 of Cr or the like in order to apply a longitudinal bias field to the free layer 11.

A method for magnetizing the ferromagnetic layer 15 of FIG. 2 is shown in FIG. 3. The ferromagnetic layer 15 is magnetized in a selected direction by applying an external magnetic field 17. The intensity of the longitudinal bias field applied to the free layer 11 from the ferromagnetic layer 15 depends on material, film thickness, and the film forming conditions of the ferromagnetic layer 15. Conventionally, it has been impossible to change the intensity of the longitudinal bias field after magnetizing the ferromagnetic layer 15.

Japanese Unexamined Patent Publication No. 1996-315325 discloses a longitudinal bias field application layer that is formed as a laminated layer made up of a plurality of magnetic field applying layers with magnetic separation layers between the longitudinal bias field application layers. The purpose is to set an MR layer and a soft adjustment layer in optimum longitudinal bias conditions. However, this patent publication relates to an MR element that has a soft adjustment layer. Accordingly, in this technology, each layer is provided with a magnetic field applying layer for applying the longitudinal bias field layer by layer, so that the MR layer and the soft adjustment layer can be in an anti-parallel condition. The intensity of the longitudinal bias field applied to the free layer is not adjusted to optimize the ability of the MR head to read a magnetic recording medium.

The ferromagnetic layer 15 of FIG. 2 suppresses Barkhausen noise generated by unstable activity in the magnetic domain of the free layer 11 due to the longitudinal bias field, but also lowers output. When the longitudinal bias field is excessively intensive, output is reduced more than necessary, but when the field is excessively weak, Barkhausen noise is generated. As explained above, the output becomes low or unstable depending on fluctuation of the longitudinal bias field. This is a significant problem for manufacturing magnetic heads. However, the manufacturing yield of magnetic heads would be improved if it were possible to adjust the longitudinal bias field after formation of the ferromagnetic layer 15.

Moreover, when the specifications of the magnetic head are changed, the ferromagnetic layer must be redesigned to generate the optimum longitudinal bias field. This requirement is a significant problem for development of magnetic heads because the development period has become shorter in recent years.

### SUMMARY OF THE INVENTION

In keeping with one aspect of this invention, a magnetoresistive element includes a free layer, a pinned layer, an antiferromagnetic layer for pinning magnetization of the pinned layer, an intermediate layer provided between the free layer and the pinned layer, and a composite ferromagnetic layer for applying the longitudinal bias field to the free layer. The composite ferromagnetic layer is formed of two or more sub-ferromagnetic layers having different coercive forces, separated by magnetic separation layers.

The longitudinal bias field to the free layer from the composite ferromagnetic layer may be adjusted even after formation of the composite ferromagnetic layer by applying a predetermined external magnetic field. The direction of the external magnetic field to be applied can be set to the direction of 180° or 90° to the direction of the longitudinal bias field.

By optimizing the longitudinal bias field after formation of the ferromagnetic layer, low output and unstable output resulting from fluctuations in the characteristics of the ferromagnetic layer can be better avoided, and manufacturing yield of magnetic heads can also be improved. Moreover, the development time of new magnetic head designs can be reduced.

### BRIEF DESCRIPTION OF DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cross-sectional view of a conventional magnetic head.

FIG. 2 is a side view of a conventional magnetoresistive element.

FIG. 3 is an explanatory diagram showing a method for magnetization of a conventional ferromagnetic layer.

FIGS. 4(a), 4(b) and 4(c) are explanatory diagrams showing a manufacturing method of a magnetoresistive element of the present invention when the sub-ferromagnetic layers are magnetized in the direction of 180° within the film surface to the direction of the longitudinal bias field.

FIGS. 5(a), 5(b) and 5(c) are explanatory diagrams showing a method of manufacturing a magnetoresistive element when some sub-ferromagnetic layers are magnetized in the direction of 90° within the film surface to the direction of the longitudinal bias field.

FIG. 6(a) is a diagram of a disk drive having the magnetoresistive element of the present invention.

FIG. 6(b) is a diagram of a head slider used in the disk drive of FIG. 6(a), showing a head slider having the magnetoresistive element of the present invention.

### DETAILED DESCRIPTION

As seen in FIGS. 4(a), 4(b) and 4(c), a read head has a free layer 11 formed of NiFe of 4 nm thickness, a pinned layer 12 formed of CoFe 2 nm thick, an antiferromagnetic layer 13 formed of PdPtMn of 15 nm thickness for pinning magnetization of the pinned layer 12, an intermediate layer 14 formed of 2 nm of Cu provided between the free layer 11 and pinned layer 12, and a composite ferromagnetic layer made up of three sub-ferromagnetic layers 15a, 15b, and 15c formed of CoCrPt of 10 nm thickness for applying a longitudinal bias field to the free layer 11. These sub-ferromagnetic layers are separated by magnetic separation layers 18a, 18b of 2 nm thickness formed of Ta among the three ferromagnetic layers above an underlayer 16 formed of 1.5 nm of Cr.

The sub-ferromagnetic layers 15a, 15b, and 15c may also be formed of CoPt, and the magnetic separation layers 18a, 18b may be formed of Cr, W. The free layer is formed of CoFe, the intermediate layer may be formed of an insulating material such as Al₂O₃, and the antiferromagnetic layer may be formed of IrMn. In addition, the pinned layer 12 may be formed in the double-layer structure of CoFe/Ru/CoFe including an intermediate material such as Ru. Furthermore, an underlayer of Ta or the like may be provided to the antiferromagnetic layer 13, with a cap layer of Ta or the like applied to the free layer 11. In addition, these magnetoresistive elements may also be laminated in the inverse sequence.

The sub-ferromagnetic layers 15a, 15b, and 15c are formed having different coercive forces. In this embodiment, the coercive forces of the sub-ferromagnetic layers 15a, 15b, and 15c respectively have 1500 Oe (H1), 2500 Oe (H2), and 2000 Oe (H3) through formation thereof using different film forming conditions. The coercive force of each magnetic layer may be varied within the range of about 1000 to 3000 Oe depending on differences in the composition of material, film forming condition, and underlayer (magnetic separation layer). Since the magnetic layers of different coercive forces are laminated, the intensity of the longitudinal bias field applied to the free layer can be adjusted with the method explained later, after formation of the composite ferromagnetic layer.

As shown in FIG. 4(a), an external magnetic field 17a is applied in the longitudinal bias direction as in the case of the conventional technology. The intensity Ha of the external magnetic field 17a to be applied is 3000 Oe (Ha>H2). When such an external magnetic field 17a is applied, the sub-ferromagnetic layers 15a, 15b, and 15c are completely magnetized in the direction of the external magnetic field 17a.

A method for adjusting the longitudinal bias field to the free layer from the composite ferromagnetic layer is shown in FIG. 4(b). Only magnetization of the ferromagnetic layer 15a is magnetized in the same direction as the external magnetic field 17b by applying the external magnetic field 17b in the intensity of Hb=1700 Oe (H1<Hb<H3) in the direction opposed to that of the external magnetic field 17a. With a 180° inversion of such magnetization, the total sum of the longitudinal bias field applied to the free layer from the ferromagnetic layers 15a, 15b, and 15c can be reduced.

As shown in FIG. 4(c), the ferromagnetic layer 15c is magnetized in the same direction as the external magnetic field 17c by applying the external magnetic field 17c in the intensity of Hc=2200 Oe (H3<Hc<H2) in the opposite direction to the external magnetic field 17a. With a 180° inversion of this magnetization, the total sum of the longitudinal bias field applied to the free layer from the ferromagnetic layers 15a, 15b, and 15c can be further reduced. The same effect can also be attained by applying the external magnetic field 17c in the intensity of Hc (H3<Hc<H2) to the magnetic head in the magnetized condition of FIG. 4(a) (without application of the external magnetic field 17b in the intensity of Hb).

The effective magnetic field applied to the ferromagnetic layer can be reduced when the external magnetic fields Ha, Hb, and Hc are partially absorbed by a magnetic shield. However, in this case, when the effective magnetic fields are assumed respectively as Ha′, Hb′, and Hc′, a higher external magnetic field must be applied to provide the results of Ha′>H2, H1<Hb′<H3, H3<Hc′<H2. This is also true in the case where the external magnetic field is applied in the direction of 90° to the direction of the longitudinal bias field.

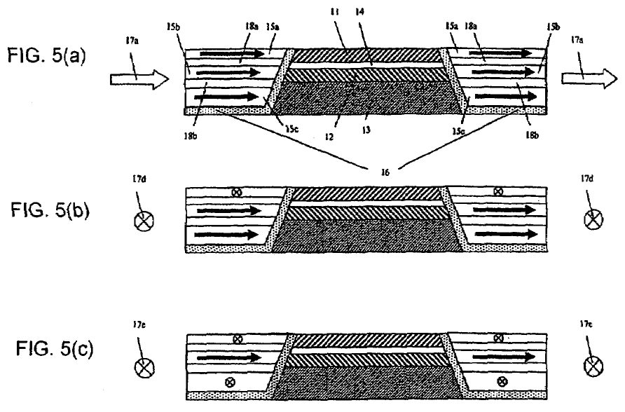

Magnetization of the sub-ferromagnetic layer 15a or sub-ferromagnetic layers 15a, 15c is oriented in the same direction as the external magnetic field 17d or 17e by applying the external magnetic field 17d in the intensity of Hb=1700 Oe (H1<Hb<H3) or the external magnetic field 17e in the intensity of Hc=2200 Oe (H3<Hc<H2) in the direction of 90° within the film surface to the direction of the longitudinal bias field, as shown in FIG. 5(b) or 5(c), under the initial magnetization of FIG. 5(a). With a 90° rotation in magnetization, a total sum of the longitudinal bias field applied to the free layer from the ferromagnetic layers 15a, 15b, and 15c can be reduced. In this case, the total sum of the longitudinal bias field is reduced to a lesser degree than that for the 180° rotation of magnetization.

With a combination of 180° and 90° rotation shown in FIGS. 4(b), 4(c) and FIGS. 5(b), 5(c), the longitudinal bias field can be adjusted in smaller steps. Three ferromagnetic layers are employed in this embodiment for holding the magnetic separation layers, but two layers or four layers may also be employed.

Since the longitudinal bias field can be lowered with the external magnetic field as explained above, the optimum longitudinal bias field can be attained easily, for example, by reducing generation of Barkhausen noise by first increasing the longitudinal bias field by about ten percent more than the ordinary field and then introducing the manufacturing method of the present invention individually to a magnetic head if it cannot provide sufficient output. Moreover, the longitudinal bias field which is once reduced can also be recovered to the initial intensity thereof by remagnetization.

The magnetoresistive element and manufacturing method thereof of the present invention can be applied in common to the magnetoresistive element provided with a layer (free layer) which changes freely in the direction of magnetization in response to the field of media such as a spin valve type element and a tunnel magnetoresistive element and to the manufacturing method thereof.

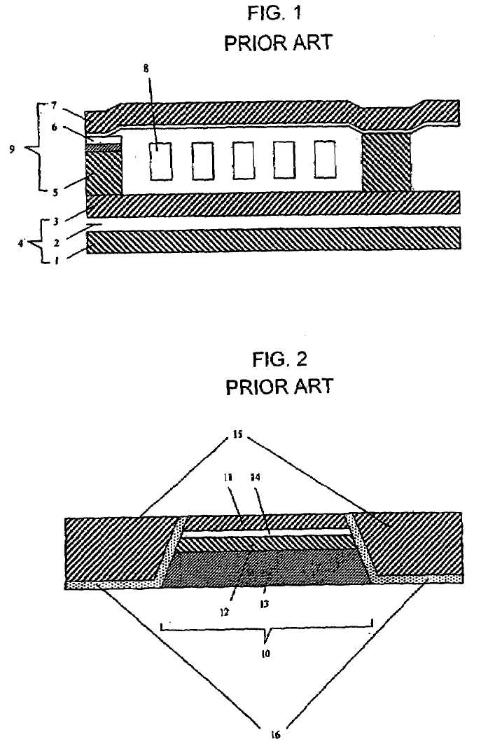

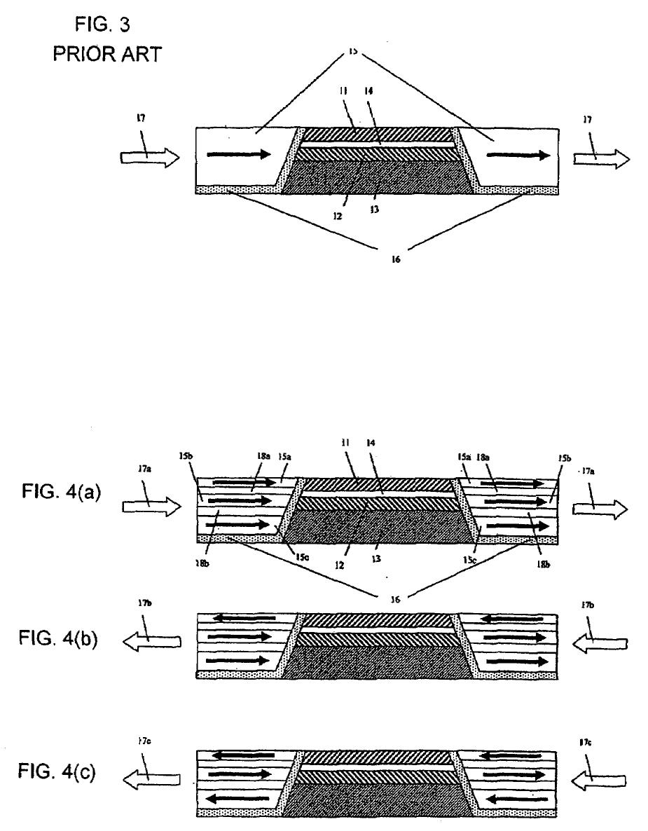

Moreover, the magnetoresistive element and manufacturing method thereof may be used not only for the magnetic head for reading the magnetic field of a medium but also for magnetic devices such as MRAM. In addition, the magnetoresistive element and manufacturing method thereof of the present invention can be used not only for horizontal magnetic recording type magnetic head shown in FIG. 1, but for perpendicular magnetic recording type magnetic heads, as well.

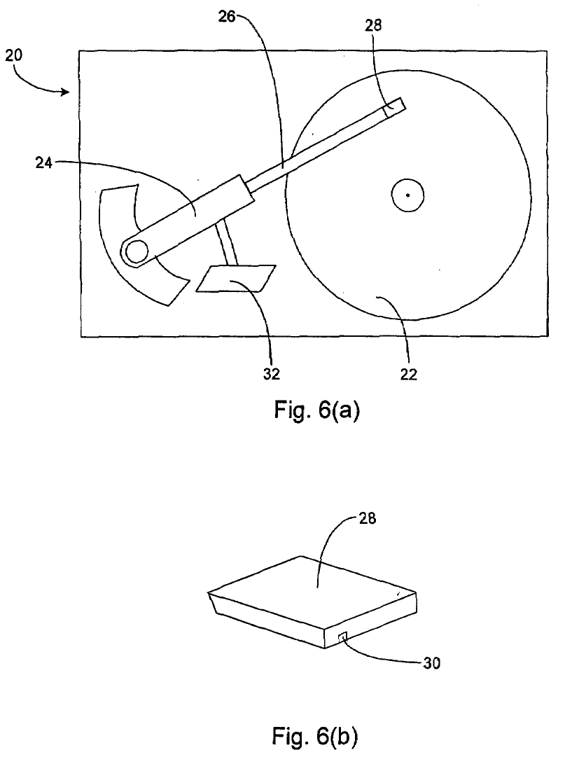

The magnetoresistive element of the present invention can be used in a hard disk drive, an example of which is shown in FIG. 6(a). A hard disk drive 20 includes at least one rotating disk memory medium 22. The disk 22 is rotated by a spindle motor (not shown). An actuator arm 24 operated by a voice coil motor or the like moves a suspension 26 across the disk 22 in a generally radial manner across the disk 22.

A head slider 28 is located at the distal end of the suspension 26, and includes a read/write element 30. The read head in the read/write element 30 is the magnetoresistive element of the present invention. Information recorded on the disk 22 is read by the magnetoresistive element as the disk rotates and the actuator moves the magnetoresistive element across predetermined tracks on the disk. A control system 32 includes controllers, memory, etc. sufficient to control disk rotation, actuator movement and read/write operations, in response to commands from a host (not shown).

While the principles of the invention have been described above in connection with specific apparatus and applications, it is to be understood that this description is made only by way of example and not as a limitation on the scope of the invention.

What is claimed is:

1. A magnetoresistive element comprising
a free layer,
a pinned layer,
an antiferromagnetic layer for pinning magnetization of said pinned layer,
an intermediate layer provided between said free layer and said pinned layer, and a composite ferromagnetic layer for applying a longitudinal bias field to said free layer,
wherein said composite ferromagnetic layer is formed of two or more sub-ferromagnetic layers of different coercive forces, each pair of sub-ferromagnetic layers being isolated by a magnetic separation layer between said sub-ferromagnetic layers.

2. The magnetoresistive element according to claim 1, wherein a direction of magnetization of at least one of said sub-ferromagnetic layers is different from the direction of magnetization of another of said sub-ferromagnetic layers.

3. The magnetoresistive element according to claim 1, comprising three sub-ferromagnetic layers, the coercive force of the first said ferromagnetic layer being about 1500 Oe, the coercive force of the second sub-ferromagnetic layer being about 2500 Oe, and the coercive force of the third sub-ferromagnetic layer being about 2000 Oe.

4. The magnetoresistive element of claim 1, wherein the sub-ferromagnetic layers are formed of CoCrPt.

5. The magnetoresistive element of claim 1, wherein the sub-ferromagnetic layers are formed of CoPt.

6. A method of manufacturing a magnetoresistive element having a free layer, a pinned layer, an antiferromagnetic layer for pinning magnetization of said pinned layer, a intermediate layer provided between said free layer and said pinned layer, and a composite ferromagnetic layer for applying a longitudinal bias field to said free layer, the composite ferromagnetic layer having two or more sub-ferromagnetic layers of different coercive forces, and a magnetic separation layer between sub-ferromagnetic layers, comprising
establishing a longitudinal bias field in said free layer by applying a first external magnetic field to said sub-ferromagnetic layers, and
adjusting the longitudinal bias field of said free layer by applying a second external magnetic field to said sub-ferromagnetic layer.

7. The method of claim 6, wherein the direction of the second external magnetic field is oriented 180° from the direction of the first external magnetic field.

8. The method of claim 6, wherein the direction of the second external magnetic field is the direction of 90° within a film surface from the direction of the first external magnetic field.

9. The method of claim 6, wherein one second external magnetic field is applied in a direction 180° from the direction of the first external magnetic field, and another second external magnetic field is applied in the direction of 90° from the direction of the first external magnetic field.

10. A disk drive comprising
a rotating disk media,
an actuator for moving a read/write element radially across the disk, and
a control system,
said read/write element having a magnetoresistive element for reading, the magnetoresistive element including,
a free layer,
a pinned layer,
an antiferromagnetic layer for pinning magnetization of said pinned layer,
an intermediate layer provided between said free layer and said pinned layer, and a composite ferromagnetic layer for applying a longitudinal bias field to said free layer,
wherein said composite ferromagnetic layer is formed of two or more sub-ferromagnetic layers of different coercive forces, each pair of sub-ferromagnetic layers being isolated by a magnetic separation layer between said sub-ferromagnetic layers.

11. The disk drive according to claim 10, wherein a direction of magnetization of at least one of said sub-ferromagnetic layers is different from the direction of magnetization of another of said sub-ferromagnetic layers.

12. The disk drive according to claim 10, comprising three sub-ferromagnetic layers, the coercive force of the first said ferromagnetic layer being about 1500 Oe, the coercive force of the second sub-ferromagnetic layer being about 2500 Oe, and the coercive force of the third sub-ferromagnetic layer being about 2000 Oe.

13. The disk drive of claim 10, wherein the sub-ferromagnetic layers are formed of CoCrPt.

14. The disk drive of claim 10, wherein the sub-ferromagnetic layers are formed of CoPt.
